(19) United States
(12) Patent Application Publication
(10) Pub. No.: US 2011/0200376 A1
(43) Pub. Date: Aug. 18, 2011

(54) PRINTER, METHOD AND COMPUTER READABLE STORAGE MEDIUM FOR PRINTING PAPER

(75) Inventor: Shuji Oozawa, Shizuoka (JP)

(73) Assignee: TOSHIBA TEC KABUSHIKI KAISHA, Tokyo (JP)

(21) Appl. No.: 12/870,113

(22) Filed: Aug. 27, 2010

(30) Foreign Application Priority Data
Feb. 17, 2010 (JP) 2010-32980

(51) Int. Cl. B41J 11/42

(52) U.S. Cl. 400/582

(57) ABSTRACT

According to one embodiment, a printer includes a sensor adapted to detect the position of a paper in a paper conveying path, a receiver adapted to receive instructions, and a measurement unit adapted to measure an output value of the sensor based on the instructions, when the paper is conveyed along the paper conveying path. The printer further includes a display unit adapted to display a result indicating whether the output value of the sensor is sufficient to detect the position of the conveyed paper by comparing the output value of the sensor with a predetermined setup value.

### CROSS-REFERENCE TO RELATED APPLICATIONS

This application is based upon and claims the benefit of priority from Japanese Patent Application No. 2010-032980, filed on Feb. 17, 2010, the entire contents of which are incorporated herein by reference.

### FIELD

Embodiments described herein generally relate to a printer and a method for controlling the same.

### BACKGROUND

Some printers print barcodes on paper, such as labels. These printers are provided with a sensor, such as a photo sensor for accurately detecting the position of labels. In these printers, a photo sensor for detecting pre-printed patterns on paper generates a detection signal, which is used to determine the position of paper.

### BRIEF DESCRIPTION OF THE DRAWINGS

FIG. 1 is a perspective view showing the outward appearance of a printer.

FIG. 2 is a perspective view showing the outward appearance of a printer whose cover is in an open state.

FIG. 3 is a schematic diagram showing a paper conveying path.

FIG. 4 is a block diagram showing a control system of a printer.

FIG. 5 is a block diagram showing the configuration of a printer control unit.

FIG. 6 is a flowchart illustrating one example of printer operations.

FIG. 7 is a view illustrating one example of displayed images.

FIG. 8 is a view illustrating one example of images displaying a sensor output and a threshold value.

FIG. 9 is a view illustrating another example of images displaying a sensor output and a threshold value.

FIG. 10 is a view illustrating a further example of images displaying a sensor output and a threshold value.

FIG. 11 is a view illustrating a still further example of images displaying a sensor output and a threshold value.

### DETAILED DESCRIPTION

According to one embodiment, a printer includes a sensor adapted to detect the position of a paper in a paper conveying path, a receiver adapted to receive instructions, and a measurement unit adapted to measure an output value of the sensor based on the instructions, when the paper is conveyed along the paper conveying path. The printer further includes a display unit adapted to display a result indicating whether the output value of the sensor is sufficient to detect the position of the conveyed paper by comparing the output value of the sensor with a predetermined setup value.

Embodiments of a printer and a program will now be described in detail with reference to the accompanying drawings. The embodiments disclose an exemplary thermal-type printer including a paper roll wound with a label paper, which has a plurality of labels adhered to a backing sheet, and printing barcodes or the like by a thermal head. The printer disclosed in the embodiments is not limited to the above mentioned thermal-type printer but may include an inkjet-type printer.

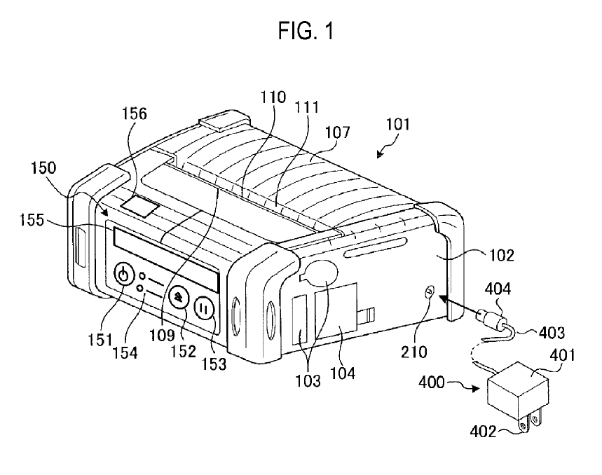

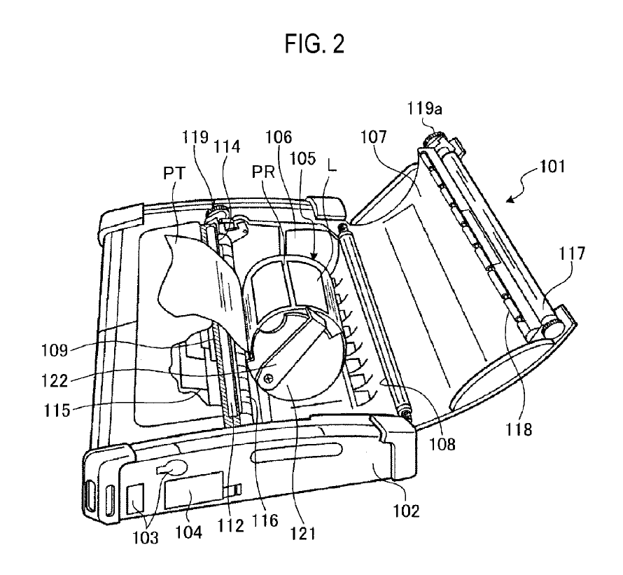

The schematic structure of a printer will be described with reference to FIGS. 1 and 2. FIG. 1 is a perspective view showing the outward appearance of a printer 101, and FIG. 2 is a perspective view showing the outward appearance of the printer 101 whose cover is in an open state.

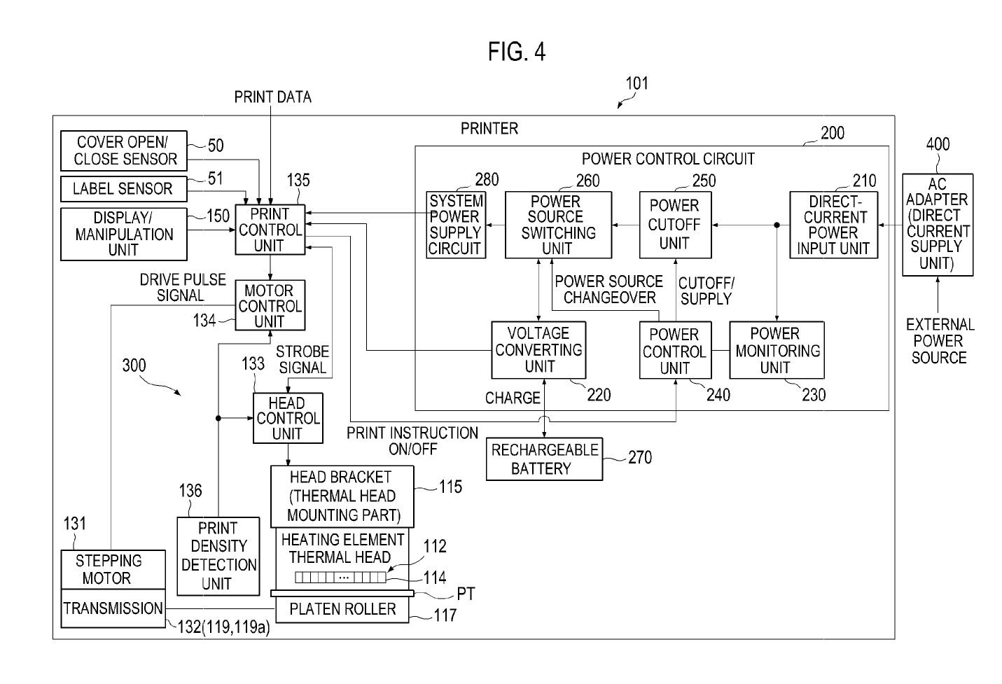

The printer 101 has a rectangular parallelepiped shape. The printer 101 includes a print mechanism 300 (see FIG. 4) to carry out a printing function and a paper feeding function, a rechargeable battery 270 (see FIG. 4) for supplying power in a housing 102. In one embodiment, the rechargeable battery 270 may be a lithium-ion battery. The housing 102 has an internal structure to store a paper roll PR wound with a label paper PT, which has a plurality of labels L (see FIG. 2) adhered to a backing sheet. An opening 106 is defined on the upper surface of the housing 102 so that the roll PR can be introduced into the housing 102 through the opening 106. A cover 107 is pivotably arranged in the opening 106. The cover 107 may open or close, which causes the opening 106 to be in an open state or a closed state.

Further, the housing 102 includes a cover opening-closing sensor 50 (see FIG. 4) for detecting the open state and the closed state of the cover 107. The cover opening-closing sensor 50 may include a micro-switch, which is one type of mechanical sensor. When the cover 107 is opened from the housing 102 to make the opening 106 open, the cover opening-closing sensor 50 comes into an off-state in which no electric current flows. On the other hand, if the cover 107 covers the opening 106, the cover opening-closing sensor 50 comes into an on-state in which electric current flows. The cover opening-closing sensor 50 is not limited to the above mentioned micro-switch, but may include a contactless switch provided with a photo sensor or other switches.

The cover 107 is attached to an inner side 108 of the housing 102 defining one side of the opening 106. When the cover 107 is in a closed state, a slot for discharging a printed label paper PT is formed between the outer side 111, i.e., the front end of the cover 107, and the front side 109, i.e., one side of the opening 106. This slot extends in the transverse direction of the printer 101 and serves as a paper outlet 110.

On one lateral surface of the housing 102, there are arranged a connector portion 103 including a variety of connectors (e.g., a universal serial bus (USB) connector) and a battery storage portion 104 for detachably enclosing the rechargeable battery 270.

The front side 109 of the housing 102 or the outer side 111 of the cover 107, respectively defining the paper outlet 110, has a sharp-edged shape to cut the label paper PT discharged from the paper outlet 110.

The housing 102 includes a paper storage portion 105 for detachably enclosing the paper roll PR. The paper roll PR is enclosed in the paper storage portion 105 with a roll shaft oriented in the transverse direction of the printer 101. The paper roll PR is unwound to be conveyed toward the paper outlet 110 by a platen roller 117 (see FIG. 1). A thermal head 112 is arranged opposite the platen roller 117.

The thermal head 112 is detachably mounted to a head bracket 115, which is arranged in the lower portion. The head bracket 115 is fixed to the housing 102 to abut against the thermal head 112 in the upper inner direction of the printer 101. A head cover 116 is arranged near the thermal head 112 at an inner portion of the printer 101. The head cover 116 is selectively mounted to the housing 102, thereby abutting against the thermal head 112 to prevent the thermal head 112 from vibrating.

The thermal head 112 includes a plurality of heating elements 114 arranged in a row with a certain density. As the heating elements 114 generate heat under the control of a head control unit 133 (see FIG. 4), the thermal head 112 prints by heating the labels L of the label paper PT. The thermal head 112 with e.g., 200 dpi or 300 dpi is mounted to the head bracket 115.

A driving gear 119 is arranged within the housing 102. The driving gear 119 is turned by a stepping motor 131 (see FIG. 4) used as a drive power source, which is operated under the control of a motor control unit 134 (see FIG. 4).

A paper pressing roller 118 is arranged near the platen roller 117 in the cover 107. The platen roller 117 and the paper pressing roller 118 are rotatable along their rotation axes extending in the transverse direction of the printer 101.

The platen roller 117 is arranged at a position in the cover 107, where it can make contact with the heating elements 114 of the thermal head 112 when the cover 107 is in the closed state. The platen roller 117 is coupled with a driven gear 119a on the left side of the platen roller 117, when viewed from the front side of the printer 101, so as to rotate together.

The driven gear 119a is engaged with the driving gear 119 so as to be driven by the driving gear 119, when the cover 107 comes into the closed state. The paper pressing roller 118 is coupled to the cover 107 at such a position that it can make contact with the head cover 116 when the cover 107 is in the closed state. When the cover 107 is closed, the driven gear 119a mounted to the cover 107 is engaged with the driving gear 119, thus rotationally driving the platen roller 117 coupled to the driven gear 119a. In the present embodiment, the driving gear 119 and the driven gear 119a serve as a transmission 132 (see FIG. 4).

In the present embodiment, the paper roll PR is arranged within the paper storage portion 105 in such a fashion that it can be attached or detached by a lever 122. The paper roll PR is positioned between two guide fences 121. The space between the two guide fences 121 can be adjusted in accordance with the width of the paper roll PR.

The housing 102 includes a direct current (DC) power input unit 210 for inputting DC power from an external power source. A plug 404 of an AC adapter 400 is inserted into the DC power input unit 210, so that DC power is supplied to the printer 101.

The AC adapter 400 is provided separately from the printer 101. The AC adapter 400 is inserted into an external commercial power socket to output DC power from the plug 404. The AC adapter 400 includes a main body 401 provided with a DC conversion circuit, a socket plug 402 attached to the main body 401, a cable 403 to output DC power, and a cable plug 404. The AC adaptor 400 converts the electric power of, e.g., AC 100V, inputted from the socket plug 402 to the electric power of, e.g., DC 20V, which is then outputted to the cable plug 404 provided at the tip end of the cable 403.

Besides a general-purpose AC adapter, a car adapter (with input power and output power of 12V), a DC-DC converter (with input power of 10V to 60V and output power of 20V) or the like may be used as the device for supplying DC power to the DC power input unit 210. If the plug 404 is connected to the DC power input unit 210, DC power is supplied to the printer 101 to drive the printer 101 or charge the rechargeable battery 270.

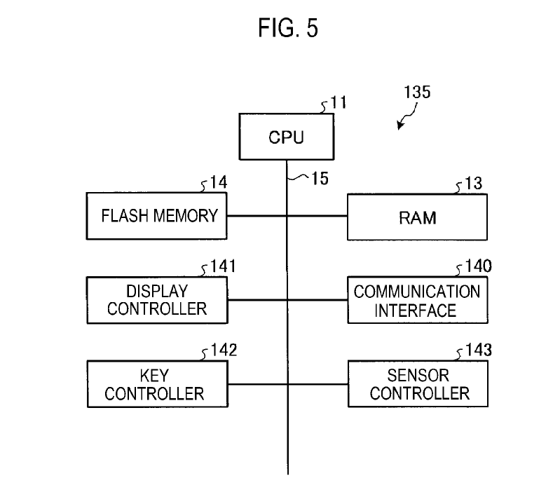

The housing 102 also includes a display/operation unit 150. The display/operation unit 150 includes a power switch 151, a paper feeding button 152 for allowing a user to instruct paper feeding, a pause button 153 for allowing a user to instruct temporary stoppage of the paper feeding. The display/operation unit 150 further includes an indicator 154 for notifying a user of the charge status of the rechargeable battery 270, a liquid crystal display (LCD) 155 and a communication window 156. In general, the printer 101 may communicate data with an external device through infrared communication via the communication window 156 and a communication interface 140 (see FIG. 5) or data communication via the connector portion 103 and the communication interface 140. For example, through communicating data, the printer 101 may receive print data such as barcodes or the like from an external device and store print data in a random access memory (RAM) 13 or a flash memory 14 (see FIG. 5) for printing. For example, an external device may include a personal computer (PC), a cellular phone, a handy terminal and an information device designed to perform a variety of arithmetic processes in response to operations input by a user.

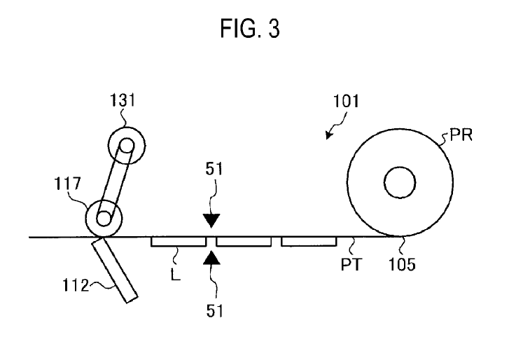

In the following, a paper conveying path extending between the paper storage portion 105 and the thermal head 112 will be described with reference to FIG. 3. FIG. 3 is a schematic view showing the paper conveying path.

As shown in FIG. 3, a label sensor 51 for detecting the position of a label paper being conveyed is arranged in a paper conveying path. The paper conveying path extends between the paper storage portion 105 and the thermal head 112. For example, the label sensor 51 is a photo sensor using light intensity to detect the positions of the labels L adhered to the backing sheet of the label paper PT. The label sensor 51 may be a transmission-type sensor for detecting the gap between the labels L adhered to the backing sheet of the label paper PT or a reflection-type sensor for detecting the labels L adhered to the backing sheet of the label paper PT. The label sensor 51 is connected to a printer control unit 135 (see FIG. 4). The printer control unit 135 compares the output value of the label sensor 51 with a predetermined threshold value (or a preset value) to distinguish the light intensity, so as to detect the labels L. In addition to detecting the positions of the labels L being conveyed, the label sensor 51 may detect black marks preliminarily provided on the label paper for printing at a specified position.

Next, the control system of the printer 101 will be described. FIG. 4 is a block diagram showing the control system of the printer 101.

As shown in FIG. 4, the print mechanism 300 of the printer 101 includes a head control unit 133 for outputting print control signals including a strobe signal and a print signal to the thermal head 112, and a motor control unit 134 for outputting a drive pulse signal to the stepping motor 131. The printer control unit 135 controls all components of the printer, including the cover opening-closing sensor 50, the label sensor 51, the display/operation unit 150 and the print mechanism 300.

The print mechanism 300 of the printer 101 includes a print density detection unit 136 to detect whether the thermal head 112 mounted to the head bracket 115 has a print density of 200 dpi or 300 dpi.

FIG. 5 is a block diagram showing the configuration of the printer control unit 135. As shown in FIG. 5, the print control unit 135 includes a CPU (central processing unit) 11 to perform various kinds of arithmetic processing to centrally control the respective components. A RAM 13 and a flash memory 14, i.e., a non-volatile memory capable of keeping stored contents despite interruption of electric power, are connected to the CPU 11 through a system bus 15.

The flash memory 14 stores operating programs and a variety of setting information of the printer 101. The CPU 11 deploys the operation programs stored in the flash memory 14 to the working area of the RAM 13, and executes the operation programs to control each component. The operation programs include a program for performing the inspection processing of the label sensor 51, which will be described later.

The RAM 13 temporarily stores a variety of variable information. For example, a partial area of the RAM 13 is used as a print buffer to which the print data (image data) to be printed on the labels L of the label paper PT are deployed. The print data, i.e., the data to be printed, may be received from an external device. The print data may be stored in the flash memory 14.

The CPU 11 is connected to a communication interface 140, a display controller 141, a key controller 142 and a sensor controller 143, via the system bus 15. Under the control of the CPU 11, the display controller 141 controls the display (e.g., a remaining battery level, radio wave reception conditions or the detection result of the label sensor 51) on the LCD 155 of the display/operation unit 150. Under the control of the CPU 11, the key controller 142 controls the key inputs received from the power switch 151, the paper feeding button 152, the pause button 153 and the like of the display/operation unit 150. Under the control of the CPU 11, the sensor controller 143 controls the inputs received from sensors such as the cover opening-closing sensor 50 and the label sensor 51.

The communication interface 140 communicates with an external device such as a host computer and the like via the connector portion 103 or the communication window 156. The communication interface 140 may include e.g., an infrared communication tool such as an IrDA or the like, a USB (Universal Serial Bus), a wireless LAN (Local Area Network), a RS-232C and Bluetooth (registered trademark). The communication interface 140 may communicate with a communication interface provided in the host computer.

Referring back to FIG. 4, the printer 101 further includes a power control circuit 200 arranged within the housing 102. Responsive to the on/off operation of the power switch 151 of the operation part 150, the power control circuit 200 performs software-control of the supply and cutoff of the electric power supplied from the external commercial power socket through the AC adapter 400 or the electric power supplied from the rechargeable battery 270. The term “software-control” refers to controlling the supply and cutoff of the electric power based on the control signals of the portable printer 101.

The power control circuit 200 includes a DC power input unit 210, a voltage converting unit 220, a power monitoring unit 230, a power control unit 240, a power cutoff unit 250, a power source switching unit 260 and a system power supply circuit 280.

The voltage converting unit 220 converts the voltage of the DC power from the DC power input unit 210 in a certain voltage range (e.g., 10V to 25V) to a voltage appropriate for recharging the rechargeable battery 270 (e.g., a voltage of 8.4V or 16.8V, which varies depending on the specifications of the rechargeable battery 270). In one embodiment, the rechargeable battery 270 is a lithium-ion battery. The rechargeable battery 270 performs its recharging operation in a CC/CV recharging method, namely in a constant current and constant voltage recharging method, by dropping the DC voltage supplied from outside.

When the recharging operation is performed, the voltage converting unit 220 may set a long-lifespan mode for prolonging the battery lifespan by varying the recharging voltage and current or by adjusting the recharge threshold value. The power monitoring unit 230 monitors the voltage of the DC power from the DC power input unit 210. The power cutoff unit 250 cuts off the DC power from the DC power input unit 210, if the voltage of the DC power detected by the power monitoring unit 230 falls outside a predetermined range (e.g., a range of 10V to 25V). The power source switching unit 260 switches the power supplied to the system power supply circuit 280, to the power supplied from the DC power input unit 210 or the power supplied from the rechargeable battery 270.

The power control unit 240 performs the control of the power cutoff unit 250 and the power source switching unit 260, as described below. If the power monitoring unit 230 detects that the DC power supplied from the DC power input unit 210 falls within a predetermined range (e.g., 10V to 25V), the power source switching unit 260 operates to allow the DC power from the DC power input unit 210 to flow into the voltage converting unit 220. The voltage converting unit 220 supplies the DC power for recharging (e.g., 8.4V) to the rechargeable battery 270. Similarly, the DC power from the DC power input unit 210 also flows into the system power supply circuit 280.

Upon receiving a print signal from the printer control unit 135 when the DC power is supplied from outside to the DC power input unit 210, the power control unit 240 operates the power source switching unit 260 to supply the power of the rechargeable battery 270 to the drive power for the print mechanism 300. Thereby, when a print instruction is received, the power supplied from the DC power input unit 210 to the print mechanism 300 is cut off. However, if the voltage of the DC power supplied from the DC power input unit 210 falls within a predetermined range, the power may be supplied from the DC power input unit 210 to the printer control unit 135.

Even when no print instruction is received, if the voltage of the DC power detected by the power monitoring unit 230 is lower than the voltage of the rechargeable battery 270, the power control unit 240 operates the power source switching unit 260 to supply the power from the rechargeable battery 270 to the system power supply circuit 280.

The system power supply circuit 280 supplies the power to each component, such as the print mechanism 300, the cover opening-closing sensor 50, the label sensor 51 and the display/operation unit 150, through the printer control unit 135. The electric power within the allowable range of voltage is applied to the thermal head 112 of the print mechanism 300. In other words, when the printer 101 prints, the electric power cutoff unit 250 cuts off the electric power supplied from the DC power input unit 210, and the power source switching unit 260 allows the electric power from the rechargeable battery 270 to be supplied to the thermal head 112, so that a voltage greater than the allowable voltage is not supplied to the thermal head 112.

The system power supply circuit 280 supplies the power (e.g., the power of 5V, 3.5V, 3.3V or 1.5V) to drive the printer control unit 135, the cover open/close sensor 50, the label sensor 51, the display/manipulation unit 150 and so forth.

As such, in the system power supply circuit 280, the operating input voltage of each component is set within the voltage range of an external DC power and the rechargeable battery 270 for the normal operation. The power supplied to the label sensor 51 may be set by the calibration, which will be described later. For example, if the power is changed from 3.3V to 3.5V by the calibration, the label sensor 51 is supplied with the changed power of 3.5V.

The system power supply circuit 280 performs the on/off control of the individual power systems that are driven by the DC power supplied from the rechargeable battery 270 and the DC power input unit 210. In other words, if the DC power input unit 210 is supplied with DC power, the system power supply circuit 280 allows DC power to flow from the DC power input unit 210 to the printer control unit 135. In contrast, if the DC power input unit 210 is not supplied with DC power, the system power supply circuit 280 allows DC power to flow from the rechargeable battery 270 to the printer control unit 135.

If the power control unit 240 allows DC power to flow from the rechargeable battery 270 to the printer control unit 135, the system power supply circuit 280 supplies the DC power to the print mechanism 300 via the printer control unit 135.

In addition to controlling the print mechanism 300, the printer control unit 135 acquires information from the voltage converting unit 220 and the system power supply circuit 280 during the power supplying period. If the voltage converting unit 220 and the system power supply circuit 280 are conditioned to allow for recharging, the printer control unit 135 transmits recharge initiation instructions to the power control unit 240.

Depending on the user's operations input through the display/manipulation unit 150 or the device circumstances such as the supply or cutoff of an external DC power, the printer control unit 135 sets the state of the printer 101 into a number of modes. For example, the modes may include an in-line mode where the thermal head 112 is directly instructed to print, an on-line mode where user's operations input through the display/manipulation unit 150 are received to perform various kinds of setting, a sleep mode where the system stays in an energy-saving state to reduce power consumption, a print mode where the thermal head 112 prints, a recharge mode where the rechargeable battery 270 is charged with power, and a long-lifespan recharge mode where recharging is performed at a low voltage without shortening the lifespan of the rechargeable battery 270.

The transition between the respective modes is controlled, as follows. When driven by the rechargeable battery 270, the printer 101 comes into the sleep mode after a certain time lapsed from the in-line mode. In the sleep mode, the power supply for unnecessary functional parts is cut off and only the communication interface 140 is in a standby state. The sleep mode comes back to the normal in-line mode if the print mechanism 300 is instructed to operate or if the communication interface 140 transmits or receives signals during the sleep mode.

When supplied with an external DC power, the printer 101 does not come into the sleep mode but stays in the normal in-line mode, which makes it possible to rapidly initiate the print mode. In the in-line mode, the communication interface 140 is in a standby state and the voltage converting unit 220 controls the recharge of the rechargeable battery 270. The printer 101 comes into the on-line mode if a certain user's operation is input through the display/manipulation unit 150 during the in-line mode. In the on-line mode, a variety of settings are established in response to the user's operation received through the display/manipulation unit 150. For example, the printing conditions are established, and sensors such as the label sensor 51 are inspected and calibrated. The printer 101 comes back to the in-line mode if a certain user's operation is received through the display/manipulation unit 150 during the on-line mode.

In the printer 101, the paper roll PR is enclosed into the paper enclosing unit 105 and the label paper PT is pulled out. If the cover 107 is closed, the pulled-out label paper PT is interposed between the thermal head 112 and the platen roller 117 and further interposed between the head cover 116 and the paper pressing roller 118. With this arrangement, if the printer 101 comes into the print mode under the control of the printer control unit 135, the motor control unit 134 controls the stepping motor 131 to drive, so that the label paper PT is conveyed from the paper roll PR toward the paper outlet 110 via the thermal head 112. The head control unit 133 controls the heating elements 114 of the thermal head 112 to generate heat, thereby printing certain information on the labels L of the conveyed label paper PT.

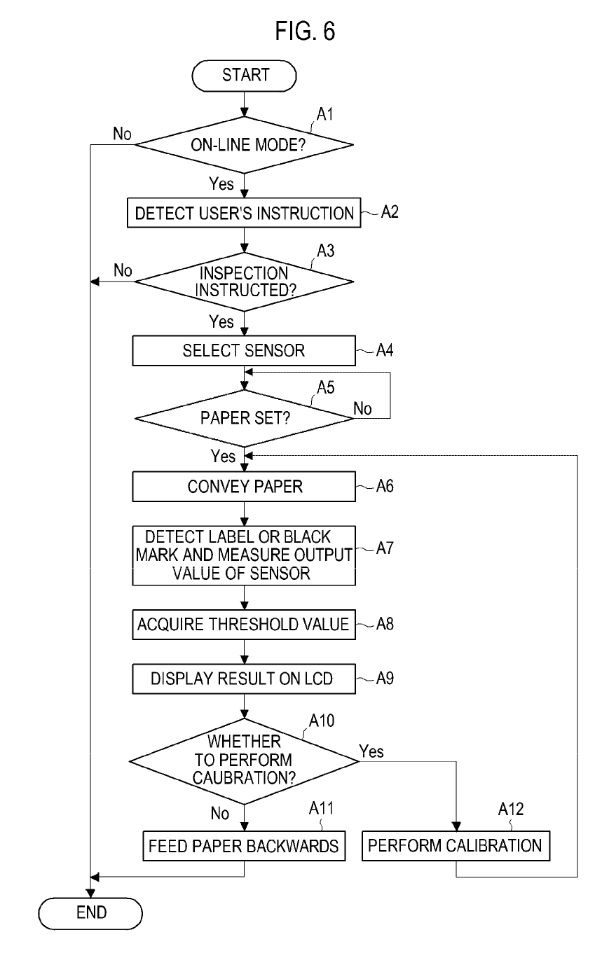

Operations of the printer 101 will be described with reference to the flowchart illustrated in FIG. 6. For example, the operations are executed to implement by the CPU 11 according to programs stored in the flash memory 14.

As shown in FIG. 6, if the processing is initiated, the CPU 11 determines whether the current mode is the on-line mode (A1). If the current mode is not the on-line mode (if “No” in A1), the CPU 11 terminates the processing. After terminating the processing, the CPU 11 controls the operations of the other modes.

If the current mode is the on-line mode (if “Yes” in A1), the CPU 11 detects user's instructions input through the display/manipulation unit 150 (A2). Then, the CPU 11 determines whether the user's instructions detected in A2 (e.g., the long press of the temporary stop button 153) are for inspecting sensors including the label sensor 51 (A3). If the user's instructions are not for inspecting sensors (if “No” in A3), the CPU 11 terminates the processing. After terminating the processing, the CPU 11 controls the operations besides inspecting sensors, such as setting the print condition in the on-line mode and the like.

If the user's instructions are for inspecting sensors (if “Yes” in A3), the CPU 11 selects a sensor to be inspected according to the user's instructions input through the display/manipulation unit 150 (A4). Specifically, the sensor to be inspected is selected among the sensors in the printer 101 (e.g., the cover open/close sensor 50 and the label sensor 51) according to the key input from the power switch 151, the paper feeding button 152 or the temporary stop button 153 of the display/manipulation unit 150. In the present embodiment, it is assumed that the label sensor 51 is selected as the sensor to be inspected.

Then, the CPU 11 determines whether the label paper PT is set (A5). The CPU 11 uses the cover open/close sensor 50 to detect the close state of the cover 107 for the determination. More specifically, after the paper roll PR is enclosed in the paper enclosing unit 105 and the label paper PT is pulled out, the CPU 11 detects the close state of the cover 107 to determine whether the label paper PT is set. In A5, the processing waits during the label paper PT setting completes (“Yes” in A5).

If the label paper PT setting completes (if “Yes” in A5), the CPU 11 causes the motor control unit 134 to output a drive pulse signal to the stepping motor 131, so that the label paper PT is conveyed (A6). When the label paper PT is conveyed, the CPU 11, as a measurement unit, instructs to detect the labels L or the black marks and measure the output value of the label sensor 51. (A7). In A7, a message reading “UNDER MEASUREMENT” or other messages may be displayed on the LCD 155 of the display/manipulation unit 150.

Next, the CPU 11 acquires a threshold value pre-stored in the flash memory 14 for detecting the labels L or the black marks (A8). Based on the output value of the label sensor 51 obtained in A7 and the threshold value acquired in A8, the CPU 11, as a display unit, instructs to display the results of inspecting the label sensor 51 on the LCD 155 of the display/manipulation unit 150 (A9). The inspection results displayed on the LCD 155 in A9 may include values indicating the positions of the conveyed labels L, e.g., the points where the measured output value of the label sensor 51 exceeds the threshold value acquired in A8. The inspection results may show whether the labels L or the black marks are normally detected.

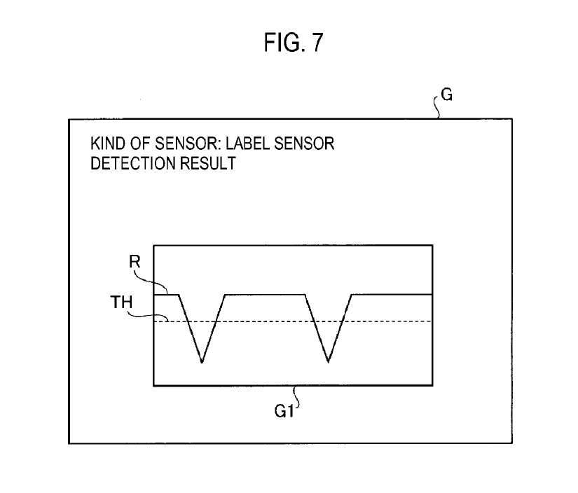

Specifically, as shown in FIG. 7, a display screen G containing the inspection result of the label sensor 51 is displayed on the LCD 155. In the display screen G, there are shown the type of the sensor selected in A4, the value of the power supplied to drive the selected sensor, the inspection result at the value of the power (the normal condition or the abnormal condition) and so forth. In FIG. 7, the display screen G shows that the inspection result is normal (OK) when the power of 3.5V is supplied to the sensor.

Therefore, the printer 101 does not waste the labels L because the inspection result of the sensor such as the label sensor 51 is not printed on the labels L but merely displayed on the LCD 155. Since the inspection result is displayed on the LCD 155, no time is required in printing the labels L, which makes it possible to shorten the time required in adjustment, e.g., calibration. Consequently, adjustment can be performed in an easier manner.

In the display screen G, there is displayed an image G1 where the sensor output R in A7 is combined with the threshold value TH. Specifically, the image G1 is a graph depicting the relationship between the sensor output R and the threshold value TH. For example, the output value of the label sensor 51 in A7 and the conveyed distance of the paper according to a drive pulse signal are stored in the RAM 13 and the image G1 may be plotted by superimposing the data stored in the RAM 13, i.e., the sensor output R against the threshold value TH. Since the image G1 plotting the sensor output R against the threshold value TH is displayed on the display screen G, a user can instinctively figure out the state of the sensor output R relative to the threshold value TH.

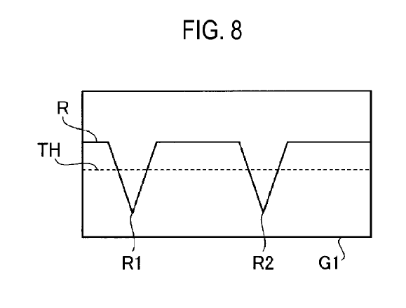

For example, the state of the sensor output R relative to the threshold value TH can be largely categorized into four states. FIGS. 8 to 11 illustrate examples of the images G1 to G4 plotting the sensor output R against the threshold value TH. In FIGS. 8 to 11, the sensor output R is indicated by inverting the output value of the label sensor 51 in a transmission-type. Therefore, the valley sections of the sensor output R correspond to the positions where the labels L are absent on the label paper PT.

As shown in FIG. 8, the valleys R1 and R2 of the sensor output R are sufficiently deep and clear in the image G1 when the inspection result is normal (OK). In the valleys R1 and R2, the sensor output R exceeds the threshold value TH, so that the light intensity may be distinguished to detect the labels L. Therefore, a user observing the image G1 can instinctively figure out whether calibration, such as changing the power supplied to the label sensor 51, is required.

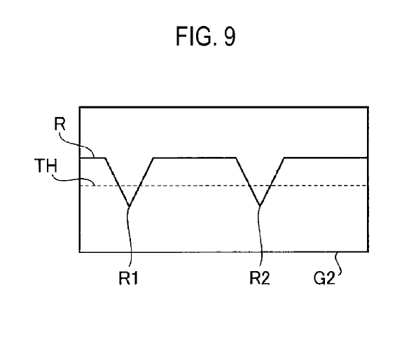

In the image G2 shown in FIG. 9, the valleys R1 and R2 are shallower than in FIG. 8, although the sensor output R exceeds the threshold value TH in the valleys R1 and R2. Accordingly, a user observing the image G2 can instinctively figure out that calibration, such as changing the power supplied to the label sensor 51, is required to make the valleys R1 and R2 deeper and clearer for the accurate measurement of the labels L or the black marks.

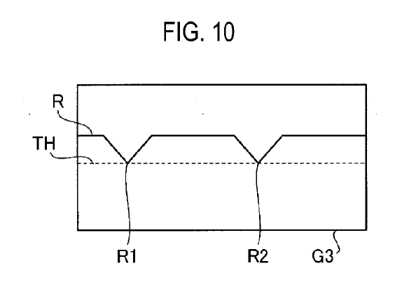

In the image G3 shown in FIG. 10, the valleys R1 and R2 are shallower than in FIG. 9 and the sensor output R does not exceed the threshold value TH in the valleys R1 and R2. Accordingly, a user observing the image G3 can instinctively figure out that although the inspection result is abnormal, the inspection result can be adjusted to normal by calibration, such as changing the power supplied to the label sensor 51.

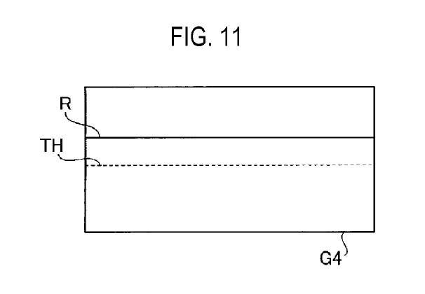

In the image G4 shown in FIG. 11, the sensor output R is flat and the valleys corresponding to the labels L or the black marks are not present in the sensor output R. Accordingly, a user observing the image G4 can instinctively figure out that the inspection result is abnormal, and the inspection result cannot be adjusted to normal by calibration, such as changing the power supplied to the label sensor 51.

The images G1 to G4 displayed on the display screen G may be icon images corresponding to the relationship between the sensor output R and the threshold value TH. Specifically, the CPU 11 determines which of the four states the sensor output R is in, by comparing the sensor output R obtained in A7 with the threshold value TH acquired in A8. Depending on the determination results, the CPU 11 reads out the icon images pre-stored in the flash memory 14 for the four states and displays the associated icon image on the display screen G. As such, a user can readily understand the state of the sensor output R by the display of the icon images indicating the relationship between the sensor output R and the threshold value TH.

Referring back to FIG. 6, description will be made on the flowchart following A9. After A9, the CPU 11 awaits signals regarding whether to perform calibration (A10).

If calibration is performed with respect to the label sensor 51 whose inspection result is abnormal according to user's instructions received through the display/manipulation unit 150 (if “Yes” in A10), the CPU 11 performs calibration, such as changing the power supplied to the label sensor 51 in response to the user's instructions (A12). After the calibration is performed (A12), the processing returns to A6. As such, the processing reiterates from A6 to A10 after the calibration, and the re-inspection result is displayed on the display/manipulation unit 150.

If the inspection result is normal or if calibration is not performed according to the user's instructions (if “No” in A10), the CPU 11 feeds backwards the conveyed label paper PT by the conveyed distance in A6 (A11). Specifically, the CPU 11 causes the motor control unit 134 to output a backward feeding drive pulse signal to the stepping motor 131. The backward feeding drive pulse signal for feeding backwards is in inverse proportion to the drive pulse signal previously outputted from the motor control unit 134 to the stepping motor 131 in A6. The distance of feeding backwards includes the conveyed distance of the label paper PT during re-inspecting the label sensor 51 after calibration. Accordingly, the printer 101 does not waste the non-printed portion of the label paper PT when inspecting a sensor such as the label sensor 51.

In one embodiment, the program executed in the printer 101 may be pre-incorporated in the flash memory 14, the ROM and so forth. Alternatively, in another embodiment, the program executed in the printer 101 may be recorded in a computer-readable recording medium such as a CD-ROM, a flexible disk (FD), a CD-R or a DVD in the form of an installable or executable file.

In another embodiment, the program executed in the printer 101 may be stored in a computer connected to a network such as the Internet so that the program can be down-loaded to from the computer via the network. Moreover, the program executed in the printer 101 may be provided or disseminated via a network such as the Internet.

In other embodiments, the program executed in the printer 101 is configured to have module containing the respective parts or units described above (e.g., the measurement unit and the display unit). From perspective of the hardware, the CPU (or the processor) reads to execute the program from the ROM. Thus, the respective parts or units are loaded to a main memory so that the measurement unit and the display unit can be formed in the main memory unit.

As used in this application, entities for executing the actions can refer to a computer-related entity, either hardware, a combination of hardware and software, software, or software in execution. For example, an entity for executing an action can be, but is not limited to being, a process running on a processor, a processor, an object, an executable, a thread of execution, a program, and a computer. By way of illustration, both an application running on an apparatus and the apparatus can be an entity. One or more entities can reside within a process and/or thread of execution and an entity can be localized on one apparatus and/or distributed between two or more apparatuses.

The program for realizing the functions can be recorded in the apparatus, can be downloaded through a network to the apparatus and can be installed in the apparatus from a computer readable storage medium storing the program therein. A form of the computer readable storage medium can be any form as long as the computer readable storage medium can store programs and is readable by the apparatus such as a disk type ROM and a solid-state computer storage media. The functions obtained by installation or download in advance in this way can be realized in cooperation with an OS(Operating System) or the like in the apparatus.

While certain embodiments have been described above, these embodiments have been presented by way of example only, and are not intended to limit the scope of the inventions. Indeed, the novel printer and the novel program described herein may be embodied in a variety of other forms; furthermore, various omissions, substitutions and changes in the form of the printer and the program described herein may be made without departing from the spirit of the inventions. The accompanying claims and their equivalents are intended to cover such forms or modifications as would fall within the scope and spirit of the inventions.

What is claimed is:

1. A printer comprising:
a sensor adapted to detect the position of a paper in a paper conveying path;
a receiver adapted to receive instructions;
a measurement unit adapted to measure an output value of the sensor based on the instructions, when the paper is conveyed along the paper conveying path; and
a display unit adapted to display a result indicating whether the output value of the sensor is sufficient to detect the position of the conveyed paper by comparing the output value of the sensor with a predetermined setup value.

2. The printer of claim 1, wherein the display unit displays both the output value of the sensor and the setup value.

3. The printer of claim 1, wherein the display unit displays an icon showing a relationship between the output value of the sensor and the setup value.

4. The printer of claim 1, further comprising: a backward feeding unit adapted to feed backwards the conveyed paper after measuring the output value of the sensor.

5. The printer of claim 1, further comprising: a calibrating unit adapted to calibrate the output value of the sensor, and wherein the display unit displays the result based on the output value of the sensor measured after the calibration.

6. The printer of claim 5, wherein the calibrating unit calibrates the output value of the sensor by changing power supplied to the sensor.

7. The printer of claim 1, further comprising: a determination unit adapted to determine whether the instructions are for inspecting the sensor.

8. The printer of claim 7, wherein the instructions for inspecting the sensor are input when the printer is in an on-line mode.

9. A printer for printing a paper having at least one of a label therein, the printer comprising:
a label sensor adapted to detect the position of a label in a paper in a paper conveying path;
a receiver adapted to receive instructions;
a measurement unit adapted to measure an output value of the label sensor in response to the instructions, when the paper is conveyed along the paper conveying path; and
a control unit adapted to generate instructions for displaying a label sensor result indicating whether the output value of the label sensor is sufficient to detect the position of the label in the conveyed paper by comparing the output value of the label sensor with a predetermined setup value.

10. The printer of claim 9, wherein the label sensor is either a transmission type or a reflection type.

11. A method comprising:
detecting the position of a paper using a sensor in a paper conveying path of a printer;
receiving instructions;
measuring an output value of the sensor based on the instructions, when the paper is conveyed along the paper conveying path; and
displaying a result indicating whether the output value of the sensor is sufficient to detect the position of the conveyed paper by comparing the output value of the sensor with a predetermined setup value.

12. The method of claim 11, wherein the displaying comprises displaying both the output value of the sensor and the setup value.

13. The method of claim 11, wherein the displaying comprises displaying an icon showing a relationship between the output value of the sensor and the setup value.

14. The method of claim 11, further comprising: feeding backwards the conveyed paper after measuring the output value of the sensor.

15. The method of claim 11, further comprising: calibrating the output value of the sensor, and wherein the displaying comprises displaying the result based on the output value of the sensor measured after the calibration.

16. The method of claim 15, wherein the calibrating comprises calibrating the output value of the sensor by changing the power supplied to the sensor.

17. The method of claim 11, further comprising: determining whether the instructions are for inspecting the sensor.

18. The method of claim 17, wherein the instructions for inspecting the sensor is input when the printer is in an on-line mode.

19. The method of claim 11, wherein the sensor is a label sensor for detecting the position of a label in the paper and the displaying comprises displaying a label sensor inspection result indicating whether the output value of the label sensor is sufficient to detect the position of the label in the conveyed paper by comparing the output value of the label sensor with a predetermined setup value.

20. The method of claim 19, wherein the label sensor is either a transmission type or a reflection type.
